(19) United States
(12) Patent Application Publication
(10) Pub. No.: US 2008/0251402 A1
(43) Pub. Date: Oct. 16, 2008

(54) Wrench Base Structure

(76) Inventor: Sophia Chiu, (US)

Correspondence Address: Dr. BANGER SHIA, 102 Lindencrest Ct., Sugar Land, TX, 77479-5201, US

(21) Appl. No.: 11/734,539

(22) Filed: Apr. 12, 2007

(51) Int. Cl. B25H 3/00

(52) U.S. Cl. 206/377

(57) ABSTRACT

A wrench base structure comprises a positioning stage and an outward-spreading arm. The positioning stage and the outward-spreading arm are formed with positioning holes and restricting holes respectively. One end of the outward-spreading arm is connected to the positioning stage by an elastic section, and the elastic section keeps the outward-spreading arm being slanted outward at a predetermined angle. By such arrangements, the force of the outward-spreading arm returning the inclined outward-spreading angle is utilized to make the restricting holes stagger with the positioning holes of the positioning stage and position the wrench which is inserted through both the restricting hole and the positioning hole. Further, it can reduce the cost of production.

### BACKGROUND OF THE INVENTION

1. Field of the Invention

The present invention relates to a wrench base structure, and more particularly to a wrench base structure which can utilize a simple structure to achieve the effect of positioning wrenches.

2. Description of the Prior Art

Since the continuous research and improvement of the hand tool design, easily portable hand tool set products have been the most convenient tool type. Moreover, a variety of wrench tool set products have come into existence in our everyday life and in manufacturing factories, but the existing wrench set still has some shortcomings to be improved.

Referring to FIG. 1, generally, most of the tool sets used on the market comprises a plurality of L-shaped wrench tool rods 10 with different sizes and a positioning base 11. Each L-shaped wrench tool rod 10 is inserted in each through hole 111 of the positioning base 11 according to its size, and the shape of the through hole 111 corresponds to the section shape of the L-shaped wrench tool rod 10. This simple wrench tool set really has the advantages of quick-assembling and easy carrying, but when in use, it has the following problems:

Since the through holes 111 of the positioning base 11 don't have the structure for positioning the L-shaped wrench tool rods 10, a conventional L-shaped wrench tool rod 10 and its corresponding through hole 111 will rub against each other and wear off the material, thus causing the through hole 111 to widen and lose the positioning effect, and causing the L-shaped wrench tool rod 10 to disengage or drop down from the through hole 111 of the positioning base 11 accidentally. Consequently, it not only loses the advantages of quick-assembling and easy-carrying, but also causes the problem of accidentally dropping.

The present invention has arisen to mitigate and/or obviate the afore-described disadvantages.

### SUMMARY OF THE INVENTION

The primary objective of the present invention is to provide a wrench base structure which can offer an effective positioning function and avoids disengaging.

The wrench base structure of the present invention comprises a positioning stage and an outward-spreading arm. The positioning stage and the outward-spreading arm are formed with positioning holes and restricting holes respectively. One end of the outward-spreading arm is connected to the positioning stage by an elastic section, and the elastic section keeps the outward-spreading arm being slanted outward at a predetermined angle. By such arrangements, the force of the outward-spreading arm returning the inclined outward-spreading angle is utilized to make the restricting holes stagger with the positioning holes of the positioning stage and position the wrench which is inserted through both the restricting hole and the positioning hole.

The secondary objective of the present invention is to provide a wrench base structure with low cost and high competitive power.

To achieve the objective of simplifying structure, the positioning stage is integrally connected to the outward-spreading arm at the elastic section by the flexible material. By such arrangements, the simple structure and the integral design of the present invention can reduce the cost of production and improve the product competitive power.

It is to be noted that, the restricting holes of the outward-spreading arm are staggered with the positioning holes of the positioning stage, so as to position the wrench which is inserted through both the restricting hole and the positioning hole firm. The shapes of the restricting holes and the positioning holes can be changed according to the shape of the handle of different wrenches, such as round holes, multangular holes, starlike holes or square holes.

The number of the restricting holes and the number of the positioning holes are adjusted according to the positioning number required by the user, for example, both being arranged with 2-10 holes, the proper adjustment of the abovementioned number is allowable.

Other relevant technology changes of the present invention are that one end of the outward-spreading arm is connected to the positioning stage by the elastic section; otherwise, the outward-spreading arm and the positioning stage also can be independent structures and are then assembled together. The integral or combined technology is just changed from the general technology, and both of them pertain to the scope of the present invention.

### BRIEF DESCRIPTION OF THE DRAWINGS

FIG. 1 shows a conventional wrench base product;

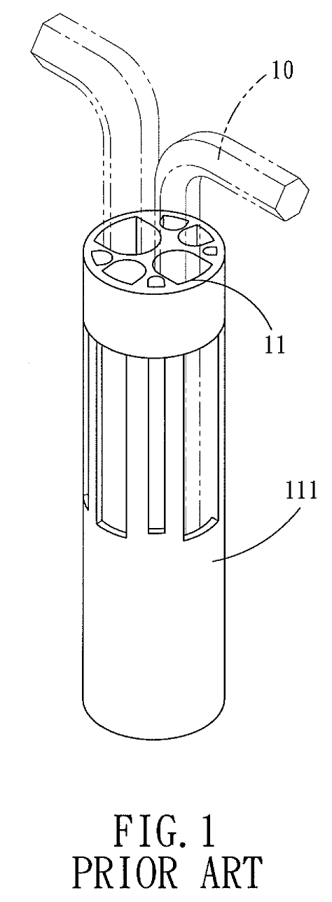

FIG. 2 is a perspective view of a wrench base structure in accordance with the prevent invention;

FIG. 3 is a bottom view of the wrench base structure in accordance with the prevent invention;

FIG. 4 is a cross sectional view of the wrench base structure in accordance with the prevent invention;

FIG. 5 is a cross sectional view of showing that the wrench base structure in accordance with the prevent invention is positioning wrenches;

FIG. 6 is a cross sectional view of showing that a wrench disengages from the base structure in accordance with the prevent invention; and

FIG. 7 shows another shape of restricting holes and positioning holes of the wrench base structure in accordance with the prevent invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

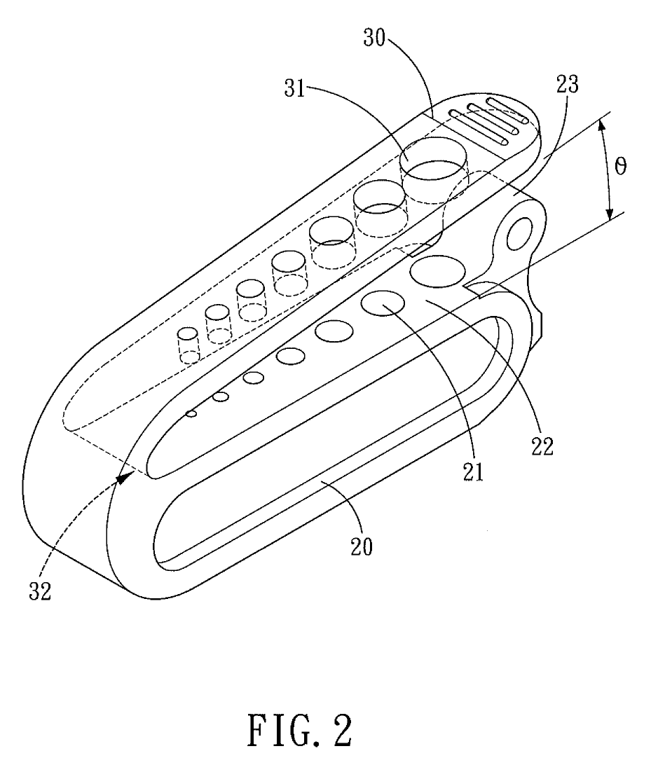

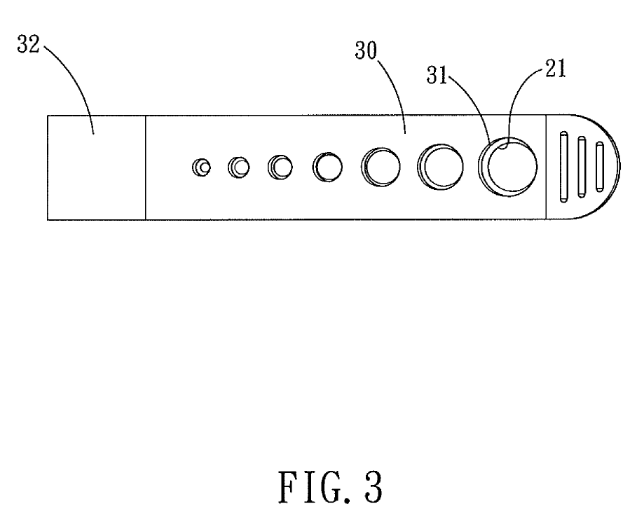

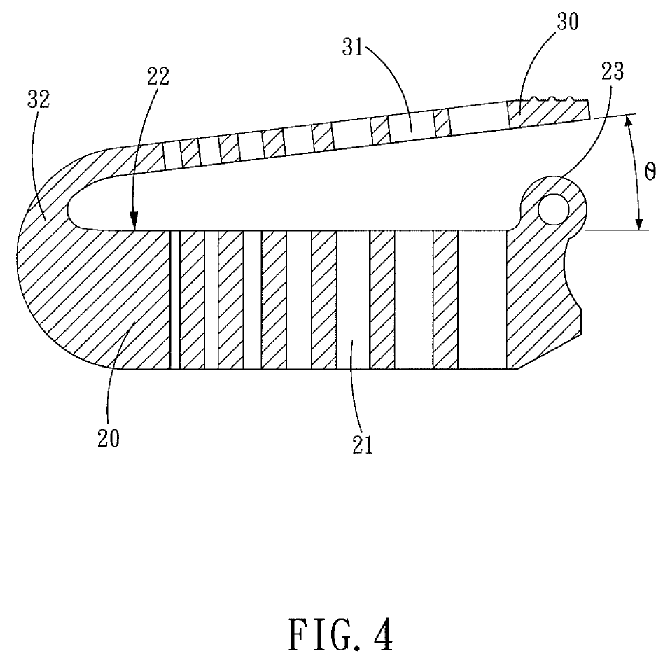

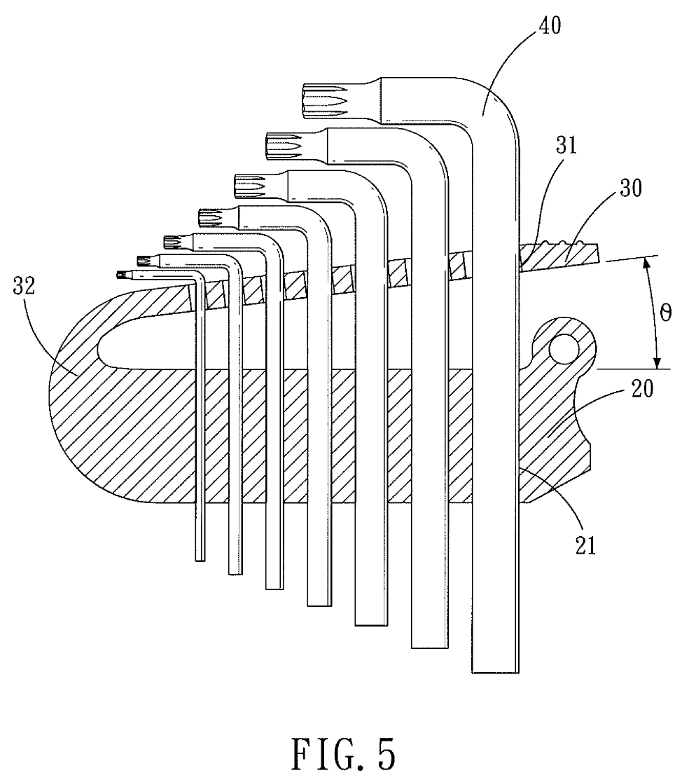

Referring to FIGS. 2-4, a wrench base structure in accordance with a preferred embodiment of the present invention comprises a positioning stage 20 and an outward-spreading arm 30 and is equipped with a plurality of L-shaped wrench 40 for use (please refer to FIG. 5), and it is characterized in that:

The positioning stage 20 is a block-shaped element, and a plane 22 of the positioning stage 20 is formed with a plurality of linearly arranged through positioning holes 21. The shape of the positioning hole 21 corresponds to the shape of the cross section of the handle of the L-shaped wrench 40. The positioning stage 20 is formed with a protruding stopping block 23 at one end of the plane 22.

The outward-spreading arm 30 is integrally connected to the other end of the plane 22 by an elastic section 32, and the outward-spreading arm 30 is connected with the positioning stage 20 to form a ∠-shaped structure with an angle (θ). The outer end of the outward-spreading arm 30 is located opposite the protruding stopping block 23, and the outward-spreading arm 30 is formed with a plurality of restricting holes 31 arranged in a line. The shape and size of the restricting holes 31 are larger than that of the positioning holes 21. When the outward-spreading arm 30 is in the free outward spreading state, the restricting holes 31 and the positioning holes 21 are staggered with each other. When the outward-spreading arm 30 is pressed down to cause deformation of the elastic section and the reduction of the angle (θ), the restricting holes 31 and the positioning holes 21 are aligned with each other.

The aforementioned is the summary of the positional and structural relationship of the respective components of the preferred embodiment in accordance with the present invention.

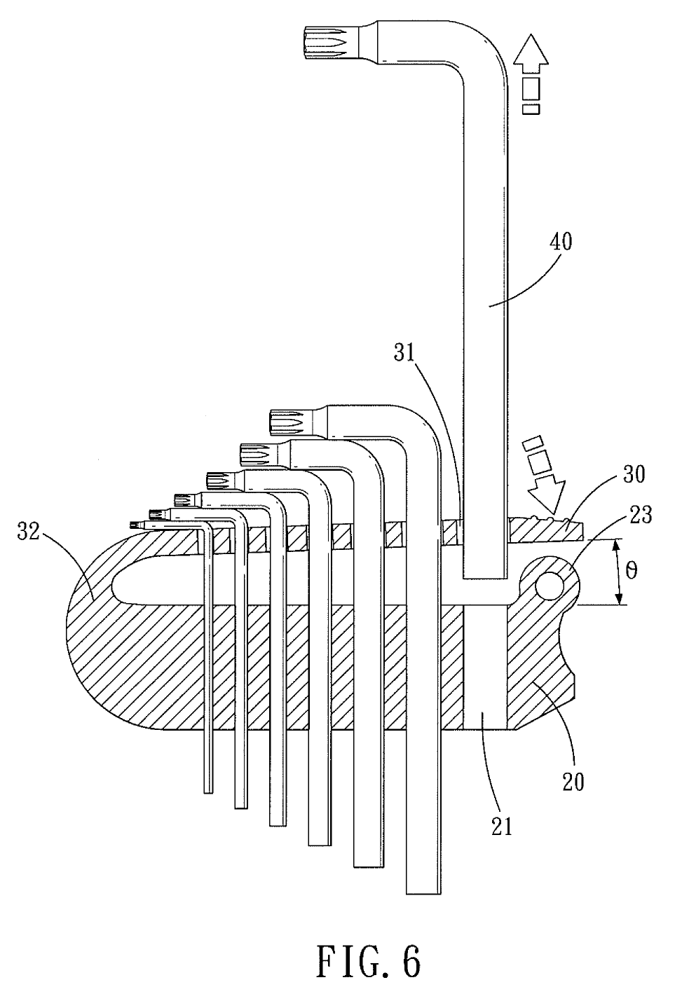

For a better understanding of the present invention, its operation and function, reference should be made to FIGS. 5-6.

The outward-spreading arm 30 is integrally connected to the other end of the plane 22 of the positioning stage 20 by the elastic section 32, and the outward-spreading arm 30 is connected with the positioning stage 20 to form a ∠-shaped structure with an angle (θ). The shapes and the sizes of the restricting holes 31 are larger than that of the positioning holes 21, and when the outward-spreading arm 30 is in the free outward spreading state, the restricting holes 31 and the positioning holes 21 are staggered with each other, when the outward-spreading arm 30 is pressed down to cause deformation of the elastic section and the reduction of the angle (θ), the restricting holes 31 and the positioning holes 21 are aligned with each other.

Hence, when the wrench base structure of the present invention is used to position the L-shaped wrench 40, the outward-spreading arm 30 is pressed down to cause deformation of the elastic section and the reduction of the angle (θ), the restricting holes 31, so that the restricting holes 31 and the positioning holes 21 are aligned with each other. At this time, the user can easily insert the L-shaped wrenches 40 through the restricting holes 31 and the positioning holes 21 respectively.

After the L-shaped wrenches 40 are inserted through the restricting holes 31 and the positioning holes 21, the user will spread out the outward-spreading arm 30, and the elastic section will elastically return, thus causing the restricting holes 31 and the positioning holes 21 to produce a pulling force which will clamp the handle of the L-shaped wrenches 40 for ensuring the positioning stability.

It is important that, if after a long time of use, partial abrasion occurs at the wrench base structure of the present invention, the elastic returning force of the elastic section 32 of the present invention can strengthen the positioning force, thus avoiding the L-shaped wrench 40 from dropping down from the wrench base structure.

In addition, since the outer end of the outward-spreading arm 30 is located opposite the protruding stopping block 23 of the positioning stage 20, the predetermined height of the protruding stopping block 23 can be utilized to prevent the outward-spreading arm 30 from being pressed down excessively and to avoid the excessive deformation and rupture of the elastic section 32.

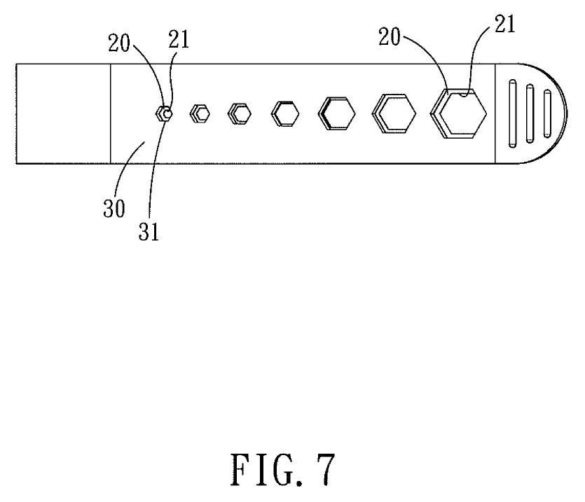

Further referring to FIG. 7, the restricting holes 31 of the outward-spreading arm 30 are staggered with the positioning holes 21 of the positioning stage 20, and the shape of the restricting holes 31 and the positioning holes 21 can be changed according to the cross sections of the handles of different L-shaped wrenches, such as the multangular holes shown in FIG. 7. The technology of the present invention also involves the starlike holes, square holes and other general hole shapes which are not shown.

Additionally, the number of the abovementioned restricting holes and positioning holes can be adjusted according to the positioning number required by the user, for example, arranging two to ten holes respectively or in the figures of the present invention, arranging seven holes from big to smaller.

Other relevant technology changes of the present invention are that one end of the outward-spreading arm is connected to the positioning stage by the elastic section; otherwise, the outward-spreading arm and the positioning stage also can be independent elements and can be fit together by combined means, both of them are included in the scope of the present invention.

To summarize, the wrench base structure of the present invention comprises a positioning sage and an outward-spreading arm. A plurality of positioning holes and restricting holes are formed in the positioning stage and the outward-spreading arm respectively, and one end of the outward-spreading arm is connected to the positioning stage by an elastic section. The elastic section keeps the outward-spreading arm being slanted outward at a predetermined angle. The force of the outward-spreading arm returning the inclined predetermined angle can be utilized to make restricting holes of the outward-spreading arm stagger with the positioning holes of the positioning stage and position the wrench which is inserted through both the positioning hole and the restricting hole firm. Further, this simple structure of the present invention can reduce the cost of production.

While we have shown and described various embodiments in accordance with the present invention, it is clear to those skilled in the art that further embodiments may be made without departing from the scope of the present invention.

1. A wrench base structure comprising a positioning stage and an outward-spreading arm and being equipped with a plurality of wrenches for use; characterized in that:
the positioning stage is formed with a plurality of through positioning holes, and a shape of the positioning hole corresponds to a shape of a cross section of a handle of the wrench, the positioning stage is further formed with a protruding stopping block at one end of a plane thereof, an outer end of the outward-spreading arm is located opposite the protruding stopping block;
the outward-spreading arm is connected to one end of the positioning stage by an elastic section, and the outward-spreading arm is connected to the positioning stage to form a ∠-shaped structure with an angle, the outward-spreading arm is formed with a plurality of restricting holes, when the outward-spreading arm is in a free outward spreading state, the restricting holes and the positioning holes are staggered with each other, when the outward-spreading arm is pressed down to cause deformation of the elastic section and a reduction of the angle, the restricting holes and the positioning holes are aligned with each other.

2. The wrench base structure as claimed in claim 1, wherein the outward-spreading arm, the elastic section and the positioning stage are integrally formed together, and the outward-spreading arm is integrally connected to the positioning stage by the elastic section.

3. The wrench base structure as claimed in claim 2, wherein the positioning stage is provided with the plane formed with a plurality of linearly arranged through positioning holes, the outward-spreading arm is integrally connected to the other end of the plane of the positioning stage by the elastic section and formed with a plurality of linearly arranged restricting holes, shapes and sizes of the restricting holes are larger than that of the positioning holes.

4. (canceled)

5. (canceled)

6. (canceled)

7. (canceled)

8. The wrench base structure as claimed in claim 1, wherein the outward-spreading arm, the elastic section and the positioning stage are independent structures and are then assembled together.
